(19) United States
(12) Patent Application Publication
(10) Pub. No.: US 2020/0147873 A1
(43) Pub. Date: May 14, 2020

(54) MULTINOZZLE PRINTHEAD WITH AN ADAPTABLE PROFILE FOR 3D-PRINTING

(71) Applicant: President and Fellows of Harvard College, Cambridge, MA (US)

(72) Inventors: Jennifer A. Lewis, Cambridge, MA (US); Sebastien Uzel, Cambridge, MA (US); Michael Eriksson, Pully (CH)

(21) Appl. No.: 16/607,587

(22) PCT Filed: Apr. 24, 2018
(86) PCT No.: PCT/US2018/029132

§ 371 Date: Oct. 23, 2019

Related U.S. Application Data
(60) Provisional application No. 62/489,279, filed on Apr. 24, 2017.

(51) Int. Cl. B29C 64/209; B29C 64/118; B29C 64/268

(52) U.S. Cl. CPC B29C 64/209; B33Y 30/00; B29C 64/268; B29C 64/118

(57) ABSTRACT

A printhead for 3D printing may include a first nozzle with a first opening configured for an extrusion of ink on a printing surface. The printhead may further include a second nozzle with a second opening configured for an extrusion of ink on the printing surface, where the first nozzle and the second nozzle are positioned to provide simultaneous extrusion of ink on the printing surface, and where a position of the first opening is independently movable relative to a position of the second opening.

### CROSS-REFERENCE TO RELATED APPLICATIONS

This application claims the benefit of U.S. Provisional Application No. 62/489,279, filed Apr. 24, 2017, which is hereby incorporated by reference in its entirety.

### FEDERALLY SPONSORED RESEARCH OR DEVELOPMENT

This invention was made with U.S. government support under contract number DMR-1420570 awarded by the National Science Foundation. The U.S. government has certain rights in the invention.

### TECHNICAL FIELD

The present disclosure is related generally to three-dimensional printing. Specifically, the present disclosure is related to a printhead, such as a multinozzle, for 3D printing onto non-planar substrates.

### BACKGROUND

Three-dimensional (“3D”) printing, also known as additive manufacturing, typically includes using a nozzle to deposit successive layers of a material under computer control. Stereolithography and direct ink writing are two examples of common 3D printing technologies. 3D printing generally encompasses a class of fabrication techniques in which structures are built in a “bottom up” mode. A 3D printer typically prints an object by depositing a material, referred to herein as an “ink,” on a substrate layer by layer. Depending on the ink and set-up, a printed object could be a complex, discrete 3D structure (e.g. open foam lattice).

3D printing is gaining acceptance as a low-cost production method for custom-designed components. However, 3D printing remains a relatively slow process, partially because by nature a 3D product has to be printed line by line, dot by dot, and layer by layer. To enable high throughput patterning, several techniques have been recently modified to incorporate parallelization schemes. For example, massively parallel variants of dip pen nanolithography, such as polymer pen lithography and hard-tip, soft-spring lithography, use multi-tip arrays composed of silicon or PDMS that deposit a low viscosity ink on a substrate to yield 2D nanoscale patterns. Parallel electrospinning simultaneously deposits nanofibers onto a substrate from independent and separate nozzles, which may be arranged in parallel on a multinozzle movable along a substrate or other printing surface. These nozzles may provide unsatisfactory results when printing on uneven surfaces, and/or when they are not in perfect alignment with the printing surface.

### BRIEF SUMMARY

One general aspect of the present disclosure includes a printhead for 3D printing, the printhead including: a first nozzle with a first opening configured for an extrusion of ink on a printing surface; and a second nozzle with a second opening configured for an extrusion of ink on the printing surface, where the first nozzle and the second nozzle are positioned to provide simultaneous extrusion of ink on the printing surface, and where a position of the first opening is independently movable relative to a position of the second opening.

Another general aspect includes a printhead for 3D printing, the printhead including: a printhead body; a nozzle coupled with the printhead body, where the nozzle includes an opening configured for extrusion of ink on a printing surface, and where the opening of the nozzle is movable relative to the printhead body in response to an input force applied to the nozzle; and a sensor configured to detect a position of the printing surface relative to the opening of the nozzle and to provide feedback for determining movement of the nozzle based on the position.

Another general aspect includes a method for 3D printing, the method including: determining a topography of at least a portion of a printing surface; extruding a first filament through a first opening of a first nozzle on the portion of printing surface; extruding a second filament through a second opening of a second nozzle on the portion of the printing surface; and moving the first opening relative to the second opening while extruding the first filament and the second filament, where the movement of the first opening relative to the second opening is based detection of the topography of the printing surface.

### BRIEF DESCRIPTION OF THE DRAWINGS

FIG. 1 shows an embodiment of a multinozzle printhead with a plurality of nozzles for 3D printing with an adaptable profile.

FIG. 2 shows the multinozzle printhead of FIG. 1 when approaching and/or when approached by a printing surface.

FIG. 3 shows the multinozzle printhead of FIG. 1-FIG. 2 where at least one nozzle is displaced.

FIG. 4 shows the multinozzle printhead of FIG. 1-FIG. 3 where at least one nozzle is further displaced with respect to FIG. 3.

FIG. 5 shows another embodiment of a multinozzle printhead with a plurality of nozzles and a plurality of guide elements for contacting an uneven surface.

FIG. 6 shows a close-up side-view of a bottom portion of the multinozzle printhead of FIG. 5.

FIG. 7 shows a close-up side-view of the bottom portion of the multinozzle printhead of FIG. 5-FIG. 6.

FIG. 8 shows certain disassembled components of an embodiment of a multinozzle printhead.

FIG. 8B shows an embodiment of a partially-assembled view of an integral nozzle, a spring receiver, and a guide element.

FIG. 9A shows a set of 3D-printed filaments extruded by a flat-profile multinozzle printhead on a curved test surface.

FIG. 9B shows a set of 3D-printed filaments extruded by an adaptive-profile multinozzle printhead on a curved test surface.

FIG. 10 shows a second set of 3D-printed filaments extruded by an adaptive-profile multinozzle printhead on a curved test surface.

FIGS. 11A-11B show top and bottom perspective views of an adaptive-profile multinozzle printhead with nozzles having integral guide surfaces.

FIG. 11C shows a nozzle depicted in FIG. 11A in isolation, the nozzle having a vertical guide.

FIGS. 12A-C show a side view and two side-perspective views, respectively, of an adaptive-profile multinozzle printhead with nozzles connected to a lever.

FIG. 12D shows a top view of an adaptive-profile multinozzle printhead with spacers located between levers.

FIG. 13 shows a diagram of a non-contact adaptive-profile multinozzle printhead.

FIG. 14 shows simplified diagram of a nozzle from the non-contact adaptive-profile multinozzle printhead of FIG. 13A.

FIG. 15A shows a perspective view of a multinozzle printhead with an adaptable profile that may operate based on input from a sensor as described above with reference to FIGS. 13-14.

FIG. 15B shows an exploded view of the multinozzle printhead of FIG. 15A.

FIG. 16A shows a first half of a multinozzle printhead with adaptive nozzle bodies.

FIG. 16B shows the multinozzle printhead of FIG. 16A with a second half included.

FIGS. 17A-B show a perspective view and a front view, respectively, of a multinozzle printhead operating on a printing surface with non-planar topography.

### DETAILED DESCRIPTION

Reference will now be made in detail to exemplary embodiments, examples of which are illustrated in the accompanying drawings. The following description refers to the accompanying drawings in which the same numbers in different drawings represent the same or similar elements unless otherwise represented. The implementations set forth in the following description of exemplary embodiments do not represent all implementations consistent with the present disclosure. Instead, they are merely examples of devices and methods consistent with aspects related to the present disclosure as recited in the appended claims.

The present disclosure relates to a printhead, such as a nozzle or multinozzle, for a 3D printing system and associated methods, and particularly printheads with multinozzles for printing on non-planar substrates. Two approaches for 3D printing on non-planar substrates are described in detail below: a contact based approach and a non-contact approach.

The printhead may be configured to form an elongated extruded filament having an inner diameter of from about 1 micron to about 15 mm in size, and more typically from about 50 microns to about 500 microns. Depending on the injection pressure and the nozzle translation speed, the deposited material may have a diameter ranging from about 1 micron to about 20 mm, and more typically from about 100 microns (0.1 mm) to about 5 mm.

The printing process may involve extruding a filament with one or composite ink formulations. The composite ink formulation(s) fed to the one or more nozzles may be housed in separate syringe barrels that may be individually connected to a nozzle for printing by way of a Luer-Lok™ or other connector. The extrusion may take place under an applied pressure of from about 1 psi to about 200 psi, from about 10 psi to about 80 psi, or from about 20 psi to about 60 psi. The pressure during extrusion may be constant or it may be varied. By using alternative pressure sources, pressures of higher than 100 psi or 200 psi and/or less than 1 psi may be applied during printing. A variable pressure may yield a filament having a diameter that varies along the length of the extruded filament. The extrusion is typically carried out at ambient or room temperature conditions (e.g., from about 18° C. to about 25° C.) for viscoelastic ink formulations. Alternatively (or in addition), the volumetric flow rate may be controlled to vary the characteristics of the filament.

During the extrusion and deposition of the continuous extruded filament, the nozzle may be moved along a predetermined path with respect to the substrate with a positional accuracy of within ±100 microns, within ±50 microns, within ±10 microns, or within ±1 micron. Accordingly, the filaments may be deposited with a positional accuracy of within ±200 microns, within ±100 microns, within ±50 microns, within ±10 microns, or within ±1 micron. The nozzle or multinozzle (i.e., a device incorporating multiple nozzles) may be translated and/or rotated, and the continuous filament may be deposited at translation speeds as high as about 3 m/s (e.g., from about 1 cm/s to about 3 m/s), and more typically in the range from about 1 mm/s to about 10 mm/s.

To increase the speed and efficiency of a 3D printing process, multiple nozzles for extruding continuous filaments may be arranged in parallel on a multinozzle. Since substrates or other printing surfaces are often not uniform in their topography, it may be advantageous to provide a nozzle or multinozzle with a profile that is adaptable to the topography of a printing surface at a particular location.

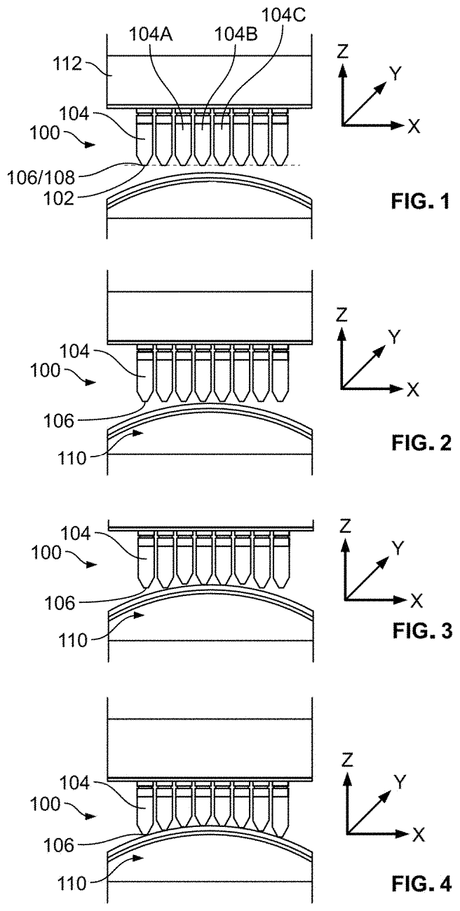

FIG. 1 shows a multinozzle 100 for 3D printing with an adaptable and/or adjustable profile 102. The profile 102 is the line formed by the tips of the nozzles 104. The multinozzle 100 may have a body 112 with at least one nozzle, such as the plurality of nozzles 104 extending from the body 112, including a first nozzle 104A, a second nozzle 104B, and a third nozzle 104C. More or less than three nozzles may be provided (such as, but not limited to, eight nozzles as shown in FIG. 1). Each of the nozzles may include an opening 106 at (or adjacent to) a distal terminus 108. The opening 106 may be in configured for the extrusion of an ink on a printing surface 110. The printing surface 110 may be, for example, the surface of a substrate and/or a surface of a partially-3D printed component. The opening 106 may be in fluid communication with an ink reservoir and/or a pump configured to extrude the ink from the opening 106.

In an exemplary embodiment, at least one nozzle is adaptable in the vertical direction in response to a force (e.g., along the z-axis). For example, when an upward force is provided on the first nozzle 104A (or another nozzle), the first nozzle 104A may move with respect to the body 112. The nozzles 104 may additionally or alternatively be movable with respect to one another (e.g., the first nozzle 104A may be movable with respect to the second nozzle 104B, the third nozzle 104C, and/or the other nozzles). As shown in FIG. 1, when no external force is applied to the nozzles 104, the profile 102 may be relatively linear. In other embodiments, the default profile may have any other suitable shape. FIG. 2 shows the multinozzle 100 of FIG. 1 at a point in time when a nozzle 104 contacts the printing surface 110 to provide feedback with respect to the spacing between the nozzle 104 and the printing surface 110. This may occur, for example, when the multinozzle 100 is lowered into communication with the printing surface 110, when the printing surface 110 is raised into communication with the multinozzle 100, and/or due to changes in the topography of the printing surface 110 as the multinozzle 100 moves in the direction of the x-axis or the y-axis. The force for moving the first nozzle 104A may be provided by the printing surface 110, or, as described in more detail below, may be provided by an automatic actuator associated with the multinozzle 100.

Referring to FIG. 3, as the printing surface 110 encroaches the original profile due to movement of the printing surface 110 and/or the multinozzle 100, the force due to the contact between the printing surface 110 and the nozzles 104 may cause at least one of the nozzles 104 to move. While the movement of the nozzles 104 is depicted as along the z-axis (e.g., in the vertical direction), it is also contemplated that the nozzles 104 may move in an additional and/or alternatively direction. FIG. 4 shows the nozzles 104 and the profile 102 further displaced with respect to FIG. 3. Advantageously, each of the nozzles 104 may be situated relatively close to the printing surface 110, even if the printing surface does not include a profile that is substantially identical to the default profile 102 of the multinozzle 100. Preferably, the individual nozzles 104 are independently movable so that the profile may adapt or conform to any linear curved, uneven, undulating, rough, bumpy, or other-shaped printing surface. Also, the independent movement of the nozzles 104 may accommodate misalignment of the multinozzle with respect to a non-perpendicular approach to flat printing surface.

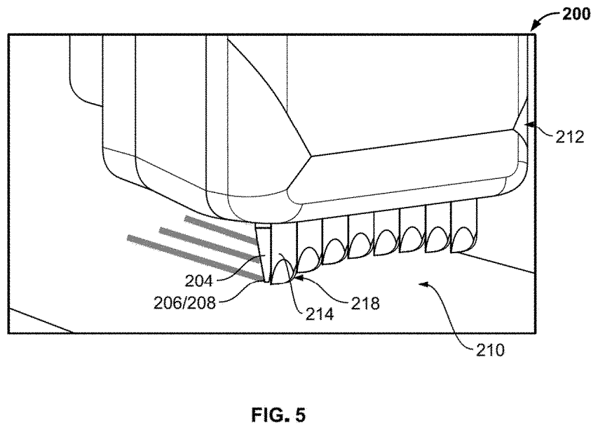

Referring to FIG. 5, a multinozzle 200 may include a nozzle 204 with an opening 206 configured for the extrusion of an ink on a printing surface 210 and a guide element 214 configured to position the nozzle 204 with respect to the printing surface 210 such that the nozzle 204 is located a distance from the printing surface 210 suitable for 3D printing. In an exemplary embodiment, it may be desirable for the terminus 208 of the nozzle 204 to be located between about 100 μm and about 1000 μm from the printing surface 210, such as about 400 μm, which may be a distance suitable for extruding a filament of ink on the printing surface 210. In non-limiting exemplary embodiments, the terminus 208 of the nozzle may be located a distance from the printing surface 210 that is approximately equal to the nozzle's diameter, which also may roughly correspond to the extruded filament diameter. Other suitable distances are contemplated.

The guide element 214 may be fixed with respect to the nozzle 204 and may be movable with respect to the body 212 such that the nozzle 204 and the guide element 214 move together. The guide element 214 may include a guide surface 218 at its distal terminus, where the guide surface 218 is configured to contact the printing surface 210. The guide surface 218 may be relatively smooth and have other characteristics to reduce friction with respect to the printing surface 210, and may include a lubricant, for example. The guide surface 218 may be spaced vertically (or in another direction) with respect to the opening 206 of the nozzle 204 such that the nozzle 204 is located a predetermined distance from the printing surface 210 when the guide surface 218 and the printing surface 210 are in contact. Thus, as the location of the printing surface 210 changes with respect to the body 212, continuous contact between the guide surface 218 and the printing surface 210 may ensure the opening 206 is continuously in a suitable location for 3D printing with respect to the printing surface 210. As described in more detail below, a spring (e.g., a helical coil spring or another suitable device) may be coupled with the guide element 214 such that the guide element 214 remains in contact with the printing surface 210.

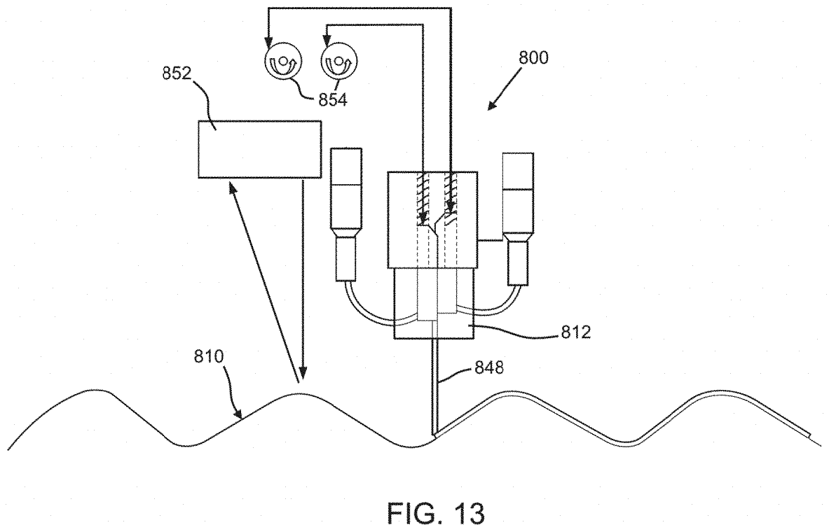

The feedback from a guide element for positioning a nozzle does not have to be mechanical feedback due to direct contact. It is contemplated a guide element may include a sensor or another device for detecting the position of a printing surface with respect to a nozzle without direct contact. For example, the guide element 214 may be replaced with a guide element having a sensor for topography registration. In such an embodiment, the nozzles of the multinozzle may be movable automatically through the use of an automatic movement device, such as an electric motor, pneumatic equipment, or another suitable device based on feedback (e.g., in the form of an electric signal) from the sensor of the guide element. When automation equipment is used, it is also contemplated that individual or groups nozzles of a multinozzle may be pre-programmed to move in a specified way with respect to a substrate during a 3D printing process. Embodiments incorporating these features are described in more detail below (e.g., with reference to FIGS. 13A-15B).

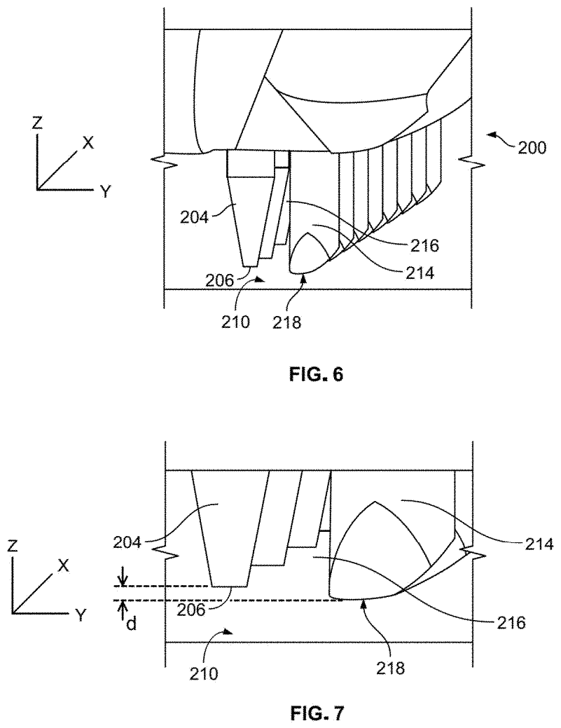

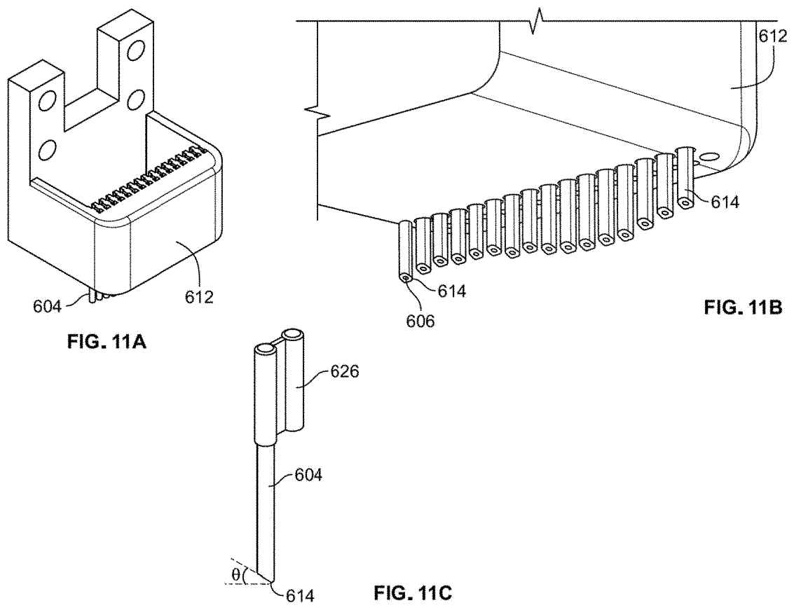

As shown in FIG. 6, a space 216 may be located between the guide element 214 and the nozzle 204. However, the space 216 is not required in all embodiments. It is contemplated that the guide element 214 may be provided by the shape of the nozzle 204 itself (as described in more detail below with reference to FIG. 11). Further, as described above and as shown in FIG. 7, the guide surface 218 of the guide element 214 may be offset a distance d, which may be approximately 400 μm in the vertical direction (e.g., along the z-axis) with respect to the opening 206 of the nozzle 204 such that the opening 206 is not restricted during extrusion. In non-limiting exemplary embodiments, this distance may approximately correspond to the diameter of a filament and/or the diameter of the opening 206. In other words, when the guide element 214 contacts the printing surface 210, the opening 206 is spaced from the printing surface 210 to allow space for extrusion of material (ink) from the nozzle 204.

The multinozzle 200 of FIG. 6 may generally move in a direction during a 3D-printing process such that the guide element 214 may be positioned in front of the nozzle 204 (with respect to the direction of movement), but this is not required. It is contemplated that the guide element 214 may be located beside or behind the nozzle 204 and/or in any other suitable location (provided that the guide element 214 does not interfere with the extruded material printed on the printing surface 210). In some embodiments, the multinozzle 200 may be capable of moving in multiple directions such that the placement of the guide element 214 changes with respect to the direction of movement, which may avoid interference of the guide element 214 with newly-extruded material, for example.

The depicted embodiments of FIGS. 5-7 include one guide element 214 per nozzle 204, but it is also contemplated that two or more guide elements 214 may be included per nozzle 204, and different nozzles 204 may be associated with different numbers of guide elements 214. Similarly, it is contemplated that a one guide element 214 may be coupled with, and thus controlling the position of, more than one nozzle 204. This may be advantageous for proving more nozzles 204 along the profile of a multinozzle without substantially increasing the profile's length, thereby increasing the resolution of the multinozzle.

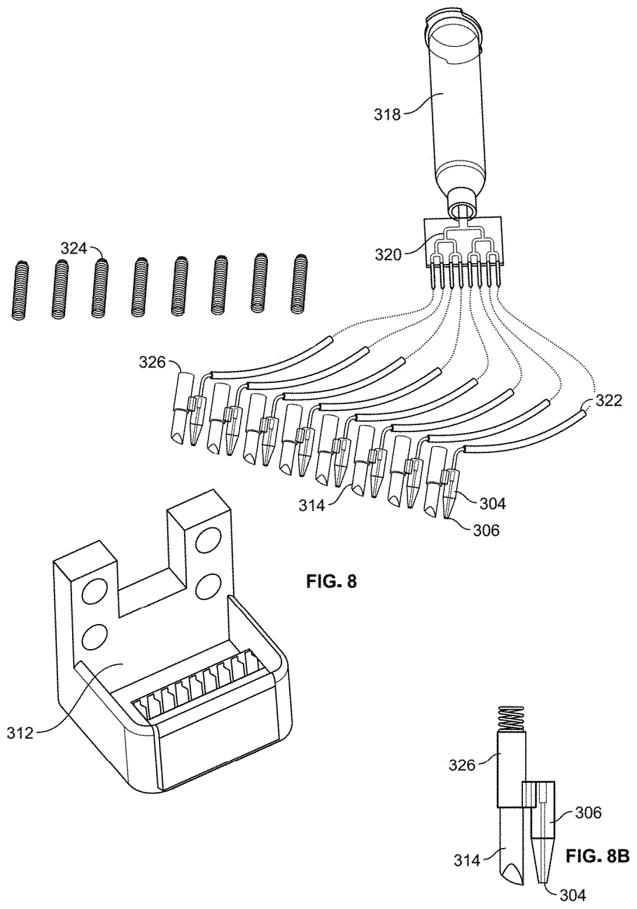

Referring to FIG. 8, a multinozzle 300, which may include any of the aspects described in herein, is shown in a disassembled condition. The multinozzle 300 may include a body 312, which may be coupled with a device suitable for moving the multinozzle 300 along a substrate during a 3D-printing process. The body 312 may be configured to attach to at least one ink reservoir 318, which may include a manifold system 320 for separating and directing ink to each of the nozzles 304. It is contemplated that multiple ink reservoirs may be included (e.g., for the use of multiple ink types), and that different nozzles 304 may be associated with different ink reservoirs. During operation, the nozzles 304 may be in fluid communication with the ink reservoir 318 such that ink may flow from the ink reservoir 318 to the openings 306 of the nozzles 304. Tubing 322 may be included between the nozzles 304 and the ink reservoir 318, which may be advantageous for providing flexibility as to the design of the location of the nozzles 304 with respect to the manifold system 320, ease of assembly, and/or ease of maintenance.

As shown, the nozzles 304 may be integral with the respective guide elements 314. The nozzles 304 and the guide elements 314 may be separate elements coupled together, and/or the nozzles 304 and the guide elements 314 may be formed of the same material, but this is not required. In some embodiments, the nozzles 304 and/or the guide elements 314 are formed as an integral monolithic element during a 3D-printing process such as stereolithography, for example.

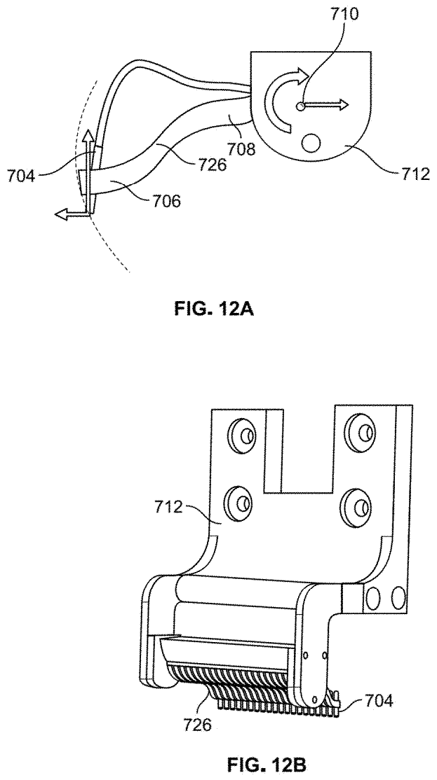

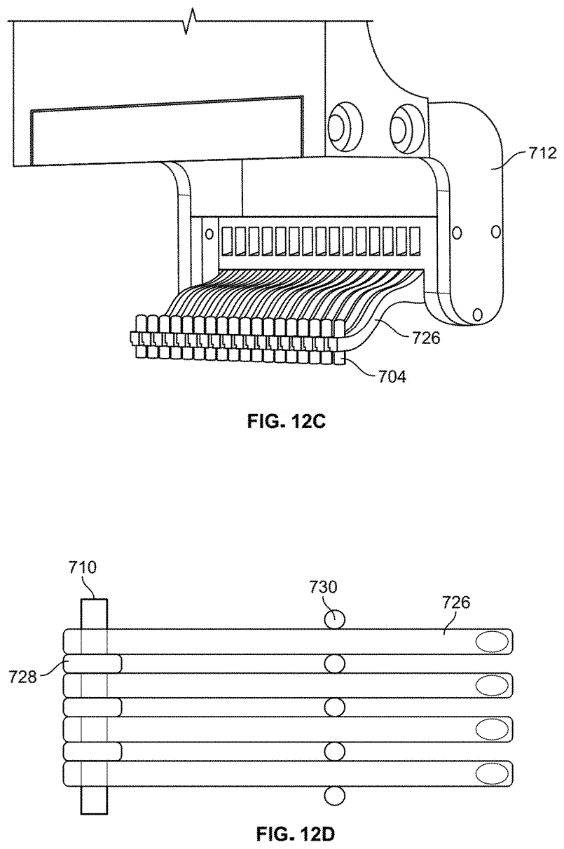

A spring 324, depicted as a metal helical coil spring, may be associated with each of the guide elements 314 and respective nozzles 304. The spring 324 may provide a default force on the nozzles 304 and/or guide elements 314 such that they remain in contact with, and a suitable distance from, a printing surface, as described in detail above. Each spring 324 may be received by a spring receiver 326 configured to couple the spring 324 to the nozzle 304. The spring receiver 326 may be integral with the guide element 314 and/or the nozzle 304, but this is not required. When the spring 324 is a helical coil spring, the spring receiver 326 may include a cavity for receiving a spring, or may alternatively fit inside the longitudinal opening extending through the spring 324. Similarly, the body 312 may include a spring receiver (not shown) configured to couple the spring to the body 312. A partially-assembled view of the integral nozzle 304, the spring receiver 326, and the guide element 314 is depicted in FIG. 8B. Other suitable devices or methods for providing the above-described default force may be included in addition to, or as an alternative to, the spring 324 (e.g., flexible tubing itself may be used to provide a spring or default tendency as shown in FIG. 12).

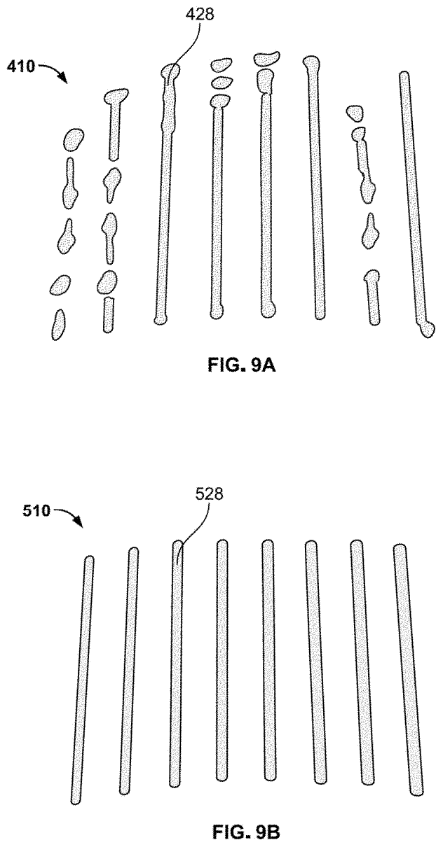

The present embodiments of an adaptive multinozzle (or printhead with an adaptive single nozzle) have been found to be advantageous for providing extruded filaments of relatively high quality when compared to other nozzles/multinozzles. Referring to FIG. 9A, when extruding filaments 428 on a curved test surface 410, a flat multinozzle (with a linear profile) may form filaments 428 of relatively low quality due to inconsistent and/or unsuitable distance between a nozzle and test surface 410. For example, certain filaments 428 may have discontinuities, inconsistent cross-sectional dimensions, and other undesirable characteristics. These undesirable characteristics may be due to inconsistent and undesirable distance between an opening of a nozzle and the test surface 410 during extrusion.

FIG. 9B shows a set of 3D-printed filaments extruded on a test surface 510 by an adaptive multinozzle in accordance with the present disclosure. Advantageously, since the adaptive multinozzle has the capability of providing a suitable distance between each nozzle of the multinozzle and the test surface 510, each of the filaments 528 may have desirable characteristics, such as relatively consistent cross-sections, few or no discontinuities, suitable adherence to the test surface 510, etc. This may be advantageous for providing the ability to form high-quality components with a 3-D printer, and may be imperative when forming components requiring precise dimensions.

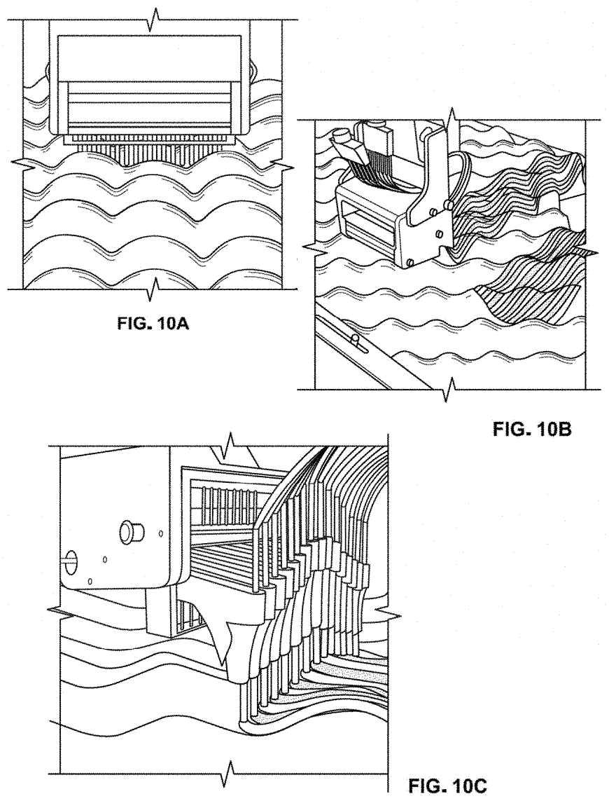

FIGS. 10A-10C show three views of a test of an adaptive multinozzle printing filaments on a non-planar test surface (e.g., using an embodiment with certain features described above in combination with certain features described below with reference to FIG. 12). As shown, the multinozzle is capable of adapting its profile (e.g., the shape formed by the tips of the individual nozzles of the multinozzle) to communicate with the test surface in a manner suitable such that the distance between each respective nozzle and the test surface are consistent even as the test surface elevates and dips with respect to the multinozzle. Thus, the present multinozzle provides suitable filaments, which may form a portion of a 3D printed component. In FIGS. 10A-10C, the adaptive multinozzle was extruding with an operating pressure of 80 psi, and the multinozzle was moving with respect to the substrate at a speed of about 20 mm/s. Other operating pressures and speeds are contemplated, and tests under different conditions are further described in the attached appendix.

In some situations, it may be advantageous to provide vertically-movable nozzles having a guide surface formed by a tip of the nozzle itself rather than (or in addition to) a separate guide element. For example, as shown in FIGS. 11A-11C, each of nozzles 604 may include a guide surface 614 located adjacent to the nozzle opening. The guide surface 614 may be angled with respect to a longitudinal axis defined by the nozzles 604, or otherwise shaped, such that the guide surfaces 614 acts as a point of contact with a printing surface to thereby guide and control the position of the nozzle 604 and/or provide space between the opening 606 and the printing substrate or surface during a 3-D printing operation such that a filament is not blocked from extrusion from the nozzle 604. In some embodiments, the guide surface 614 is angled or chamfered at an angle θ with respect to a plane defined by a printing surface (which may be true horizontal). For example, the angle θ may be between about 10 degrees and about 80 degrees, such as from about 20 degrees to about 60 degrees, and about 45 degrees in one particular embodiment. As shown, the nozzle 604 may be coupled with a vertical guide 626 that may be associated with a track (e.g., a cylindrical cavity) of the body 612 that supports the nozzles 604 and ensures the nozzles 604 remain in a suitable orientation for printing. The vertical guide may also act as a spring receiver in some embodiments.

The embodiment of FIGS. 11A-C may reduce spacing between the opening 606 and the contact point of the guide surface 614 compared to other embodiments, thereby reducing or eliminating a delayed or advanced nozzle movement (e.g., due to feedback provided on a guide element before or after the nozzle reaches a particular terrain of the printing surface), which may be advantageous for providing an enhanced ability to cope with relatively sudden and extreme inclines on the printing surface when compared to other embodiments. Further, in this embodiment, the nozzles 604 and the spacing between the nozzles 604 (which may be about 3.8 mm, as shown, though other suitable distances are also contemplated) may be relatively small such that an associated 3-D printer has a relatively high-resolution.

In another embodiment, a multinozzle may include a plurality of levers to direct the vertical movement of the individual nozzles, as shown in FIGS. 12A-C, where each lever 726 is attached to a nozzle 704. Referring to FIG. 12A, a first end 706 the lever 726 may be coupled to the nozzle 704 in a fixed or non-fixed (e.g., rotational) manner. In an exemplary embodiment, the nozzle 704 is substantially fixed with respect to the lever 726. A second end 708 opposite the first end 706 of the lever 726 may be pivotally attached to a printhead body 712 at a pivot axle 710. When the lever 726 rotates with respect to the body 712, the nozzles 704 may displace in the vertical direction, e.g., which may also be in a circular path, as shown. Advantageously, this embodiment may provide the ability of the nozzles 704 to move vertically in response to varying topography conditions of a printing surface due to rotation of the lever 726 with respect to the body, and also may be associated with simpler manufacturing and assembly techniques with respect to other nozzles. With respect to other embodiments, including the nozzles 704 on the levers 726 may also reduce or eliminate sticking or locking of the nozzles 704 otherwise caused by friction provided by torque on the nozzles 704 while they are within the track. Thus, this embodiment may be advantageous when a particular printing surface has characteristics conducive of a relatively high amount of torque (e.g., by providing lateral forces) on the nozzles 704.

As shown in FIGS. 12B-C, each lever 726 may be associated with a single nozzle 704. In other embodiments, multiple nozzles 704 may be associated with each lever 726. The levers 726 may be independent of one another and thus be movable/rotatable with respect to one another. Alternatively, at least some of the levers 726 may be substantially fixed to one another such that they pivot and rotate together. As illustrated by FIG. 12A, the material forming the lever 726 may have certain mechanical properties (e.g., a particular resilience) for providing a downward spring force when displaced upwards, thus keeping the nozzle 704 a suitable distance from a printing surface. In other embodiments, springs (e.g., torsion springs, which are not shown) may be coupled to the levers 726 such that the rotation of the levers 726 is biased by the torsion springs, thereby countering at least a portion of the weight of the levers 726. Alternatively, the torsion springs may provide a tendency for the levers 726 to rotate the opposite direction to press downward on the nozzles 704 to facilitate continuous contact between the nozzles 704 and a printing surface. Further, it is contemplated that a spring force may be at least partially provided by the mechanical properties of the material forming the lever 726 (e.g., elasticity and resilience) rather than (or in addition to) a separate spring device.

In some embodiments, the levers 726 may be associated with spacers 728 and/or spacers 730 as shown in FIG. 12D. The spacers 728, 730 may be formed of a low-friction material, such as low-friction stainless steel for example, to advantageously limit rotational and/or vertical constraint of the levers 726. The spacers 728 may be located at the pivot axle 710 of the levers 726. Additionally or alternatively, other spacers 730 may be positioned at another location along the body of the levers 726. The spacers 728, 730 may be fixed with respect to at least one lever 726 and/or with respect to the body of the multinozzle. The side surfaces of the levers 726 may be formed of a particular material and shaped for low-friction contact with the spacers 728, 730 or otherwise optimized for spacer contact. The spacers 728 may also be advantageous for providing extra space for tubing connected to the nozzles. It is contemplated that this extra space between nozzles may reduce or prevent contact among individual tubes leading to individual nozzles from interrupting suitable nozzle displacement. The extra spacing may also be advantageous when it is desirable to use larger nozzles or include other components coupled to the nozzles and/or levers 726.

FIG. 13 shows a side-view diagram of a printhead, in this case a multinozzle 800, with nozzles 848 for extruding ink on a printing surface 810. The printhead/multinozzle 800 may be similar to the embodiments described above with one primary difference: it utilizes feedback from a non-contact sensor 852 to adapt its profile to account for varying topography of a printing surface. Advantageously, the lack of contact between the multinozzle 800 and the substrate or printing surface 810 may make it amenable to use with a fragile substrate and allow multi-layer printing (e.g., without a contact-based guide element causing damage to the already-printed layer). As shown in FIG. 13A, at least one sensor 852 may be included and may be configured to sense the topography of a printing surface 810, such as by determining the distance between the sensor 852 and a particular location of that printing surface 810. The sensor 852 may be any suitable type of sensor 852, such as a laser scanner (such as a Keyence LJ-V Series laser scanner in one embodiment), a camera, an optical position sensor (e.g., a 2-D tetra-lateral PSD), or any other suitable sensor. In some embodiments, the sensor 852 is coupled to a printhead body 812 and “leads” the nozzles 848 (e.g., it senses the topography just in front of the nozzles 848 in real-time as the printhead body 812 moves). In other embodiments, the sensor 852 may move independently from the printhead body 812 such that it can scan and collect topographical information about the printing surface 810, which may be analyzed, stored, and then used by the device as the nozzles 848 operate at a later time. A different sensor may be associated with each nozzle 848, or a single sensor may provide information for the translation of multiple nozzles. The sensor information may be collected by a data acquisition system and then that information may then be analyzed and used by a control system (e.g., by an Arduino MEGA control system in some embodiments). The control system may then relay control information (e.g., electronic control signals) to one or more actuators 854, which may be mechanically coupled to the nozzle 848 and configured to translate at least one nozzle based on changing printing-surface topography of the printing surface 810.

In some embodiments, the information from the sensor 852 may be manipulated by the control system (e.g., by smoothing software) or otherwise be manipulated for proper capability with, and performance of, the actuators 854. Further, in some embodiments, a separate control system (i.e., separate from the system controlling the sensors and/or acquiring sensor data) may control the actuators 854 (e.g., an Aerotech A3200 software-based motion controller). The actuators 854 may be electric motors, but other actuator types are also contemplated. Each nozzle 848 may be associated with a separate actuator 854 of an actuator array (as shown in more detail below), a single actuator 854 may control multiple nozzles 848, and/or a single actuator 854 may have the capability of coupling and decoupling from certain nozzles 848 to thereby select which nozzles 848 are translated.

While exemplary embodiments include a sensor 852, it is also contemplated that the control system may be programmed for particular translation of the nozzles without input from a sensor 852, or at least without real-time sensor feedback. For example, if the topography of the printing surface 810 is known ahead of time (e.g., due to a standardized or selected printing surface, or due to pre-scanning with a sensor 852), the control system may be programmed to control the nozzles 848 such that they follow a pre-determined path.

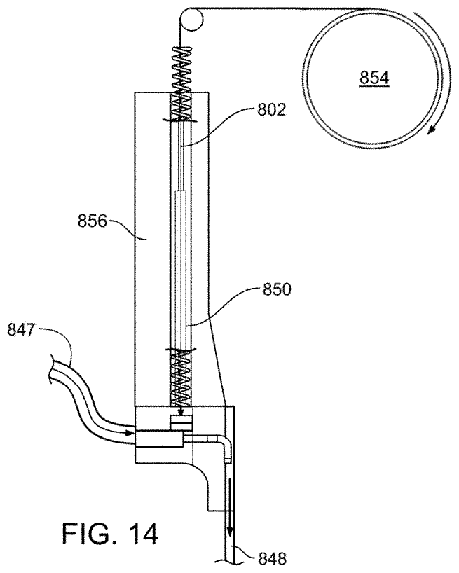

FIG. 14 shows a simplified side-view diagram of a 3D printing system with a nozzle body 856 connected to an actuator 854 (or driven pulley driven by the actuator 854) via a wire 802 (or other strand of material), such as a wire formed from Kevlar. The wire 802 may extend through tubing (e.g., PEEK tubing), which may provide a guide for the wire 802. The wire 802 may extend through a wire conduit 850 and may be secured with the nozzle body 856 at a location within the wire conduit 850. The wire 802 may effect vertical movement of the nozzle body 856. As depicted in FIG. 13B, a spring may be coupled to each nozzle body 856 such that the default (or passive) state of the nozzle body 856 can be controlled when the motor is not acting on the nozzle (e.g., to assist in moving the nozzles 848 and coupled nozzle bodies 856 to the default position when tension is released from the wire). The nozzle 848 may extend from the nozzle body 856, may be fixed to the nozzle body 856 such that it moves when the nozzle body 856 moves. An ink inlet 847 may be in fluid communication with the nozzle 848 through the nozzle body 856. Connecting each actuator to a nozzle 848 (e.g., through a nozzle body 856) via a wire 802 (rather than directly) may be advantageous for allowing separate packaging of the nozzles 848 with respect to an actuator array such that the actuators do not take up limited space on a printhead body, for example (which may be advantageous for enhancing the maneuverability of the printhead body 812 by limiting its size). Similarly, ink reservoirs and/or a pressure source may be located in a location separated from the printhead body, and the ink may be fed to the nozzles via tubing. The resulting printhead may include a relatively large number of nozzles 848 without significantly increasing the printhead body's size.

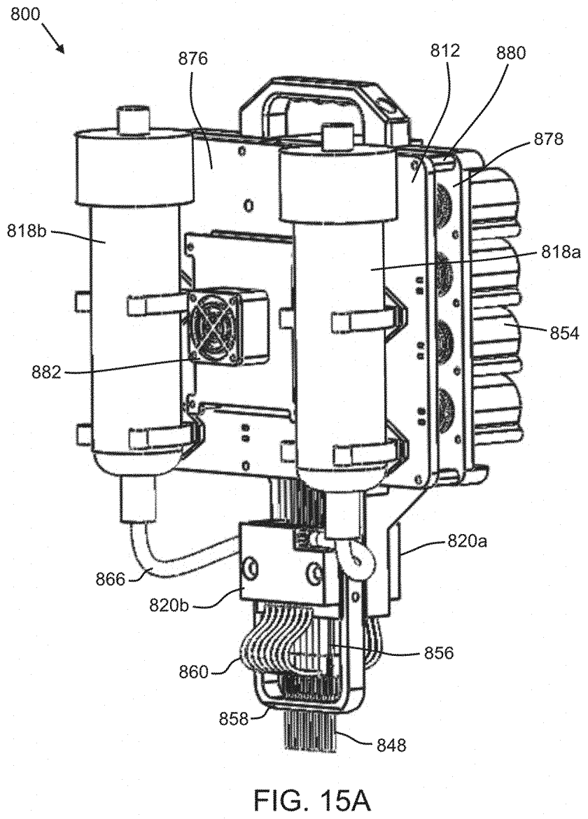

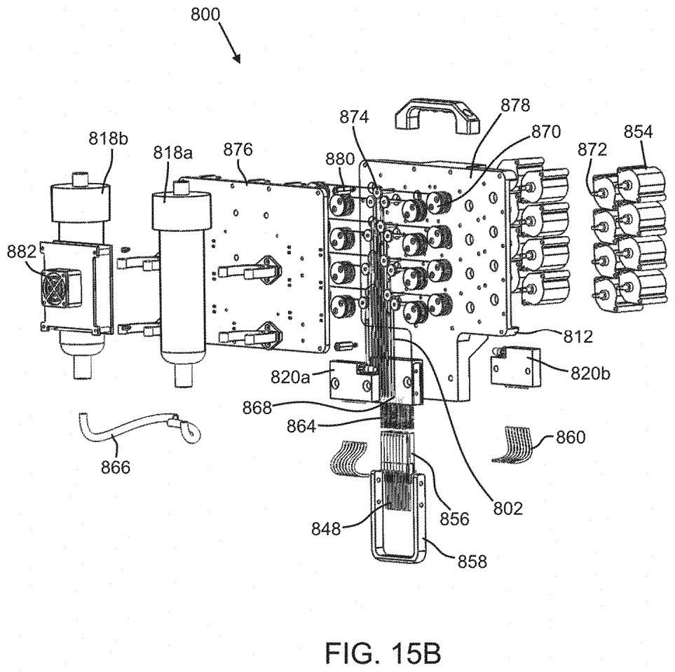

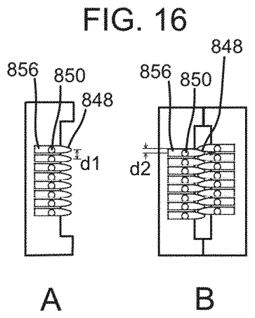

FIG. 15A shows one embodiment of the printhead (in this case a multinozzle 800) with an adaptable profile that may operate based on input from a sensor as described above with reference to FIGS. 13-14. FIG. 15B shows an exploded view of the multinozzle 800 of FIG. 15A for purposes of illustration. As shown in FIGS. 15A-B, the multinozzle 800 may include a plurality of nozzles 848 (in this case, 16 nozzles 848) coupled to nozzle bodies 856. The nozzles 848 may be protected and/or guided by a support arm 858, which may have an opening that receives each of the nozzles 848 (e.g., one opening for each nozzle, or one opening for all nozzles). The nozzle bodies 856 may be coupled to an ink manifold 820 via tubes or hoses 860. The nozzles 848 may be coupled to a one or more ink manifolds 820. Nozzles 848 coupled to a single manifold may extrude ink simultaneously (unless one or more of the nozzles is associated with a valve located downstream of the respective manifold), for example. In the depicted embodiment, two ink manifolds 820a, 820b are included. The ink manifolds 820a, 820b may be similar or identical to the manifold system 320 shown in FIG. 8. As shown in FIGS. 15A-B, eight nozzle bodies 856 are coupled to (e.g., in fluid communication with) the first ink manifold 820a, and the other eight nozzle bodies 856 are coupled to the second ink manifold 820b. This may be advantageous since alternating nozzle bodies 856 may face different directions (e.g., consecutive nozzle bodies 856 may be rotated 180 degrees), which may provide the advantage of packaging the nozzle bodies 856 in a smaller area as described below with reference to FIGS. 16A-B). It is also contemplated that utilizing different ink manifolds may provide the ability to print with multiple types of ink at once, but this is optional.

The ink manifolds 820 may be respectively coupled to a first ink reservoir 818a and a second ink reservoir 818b via reservoir tubes or hoses 866. The ink reservoirs may contain the same type of ink or different types of ink, and in other embodiments, only one ink reservoir (or more than two ink reservoirs) may be included. The ink reservoirs 818 may be pre-loaded with a pressure to force ink to the nozzles 848, but in exemplary embodiments, a pressure-controlling actuation device may be included (not shown) to selectively provide pressure to the ink reservoirs 818, and thus selectively cause the nozzles 848 to extrude ink.

To adapt the profile of the multinozzle 800 (that is, to move the nozzles 848 vertically in response to variable topography of a printing surface), each of the nozzle bodies 856 (which are fixed with respect to the nozzles 848) may be coupled to respective first ends 868 of the wires 802 (shown simplified in FIG. 14). The opposite end of the wires 802 may be driven by a drive pulley 870, which may be fixed to an axle 872 of an actuator 854. Idler pulleys 874 may be included as needed to direct the wires 802 from the drive pulleys 870 to the nozzle bodies 856. The springs 864 may force the nozzle bodies 856, and thus also the nozzles 848, into a default state (shown in FIG. 15B) when the actuators 854 do not provide any input force. A simplified diagram of these components is shown above in FIG. 13B.

The above-described components of FIGS. 15A-B may generally be held together via a printhead body 812, which may include a first panel 876 and a second panel 878 that are fixed via one or more connectors 880. While any suitable arrangement is contemplated, in the depicted embodiment, the first panel 876 may house the first and second ink reservoirs 818 and a cooling fan 882 (e.g., which may control the temperature of the actuators 854 or other components associated with the production of heat). The second panel 878 may house the actuators 854. The pulleys 870, 874, wires 802, ink manifolds 820, springs 864, and/or nozzle bodies 856 may generally be held between the first panel 876 and the second panel 878.

FIG. 16A shows one half, and FIG. 16B shows two halves, of a top illustration of the multinozzle depicted in FIGS. 15A-C. Referring to FIG. 16A, each nozzle body 856 is depicted as including a wire conduit 850. The wire conduit 850 may receive the wires 802 (see FIG. 13B) leading to the actuators and the nozzles 848, for example (where the nozzles 848 are located beneath the tip of the nozzle bodies 856). When the nozzles are positioned relatively close together (e.g., d1, which may be about 5 mm, for example), the wire conduits 850 may have a diameter of about 4.5 mm, which may be suitable for providing room for components of appropriate size and strength, and also appropriate durability of the nozzle bodies 856. The diameter of the wire conduits 850 may limit the minimum spacing between nozzles on the depicted one half of the multinozzle. It is also contemplated that an element other than a wire conduit may be the limiting factor with respect to minimum nozzle spacing.

As shown in FIG. 16B, the second half of the multinozzle may include the nozzle bodies 856 (and nozzles 848) that are offset with respect to those of the first half in the lateral direction (which as depicted in FIGS. 16A-16B is the direction parallel to a plane extending through all of the nozzles 848 of one of the halves). The ends of the nozzle bodies 856, and therefore the nozzles 848 themselves, of the second half may therefore fit between the ends of the nozzle bodies 856 of the first half, as shown. Advantageously, the nozzles 848 of each half may be located in a single row (e.g., in a linear profile from at least the bottom perspective of FIG. 16B). Further, the lateral nozzle spacing may be roughly half of the spacing with respect to the nozzles 848 of individual halves. In other words, when the nozzle centers are spaced about 5 mm apart in the lateral direction on one half, when combined with the other half, the overall lateral spacing between the centers of the nozzles 848 (e.g., shown as d2) may be about 2.5 mm, or less. Advantageously, this reduced spacing may be achieved without reducing the size, and therefore the strength and durability, of certain components of the multinozzle, and it may provide the multinozzle with increased resolution with respect to a multinozzle with larger lateral nozzle spacing.

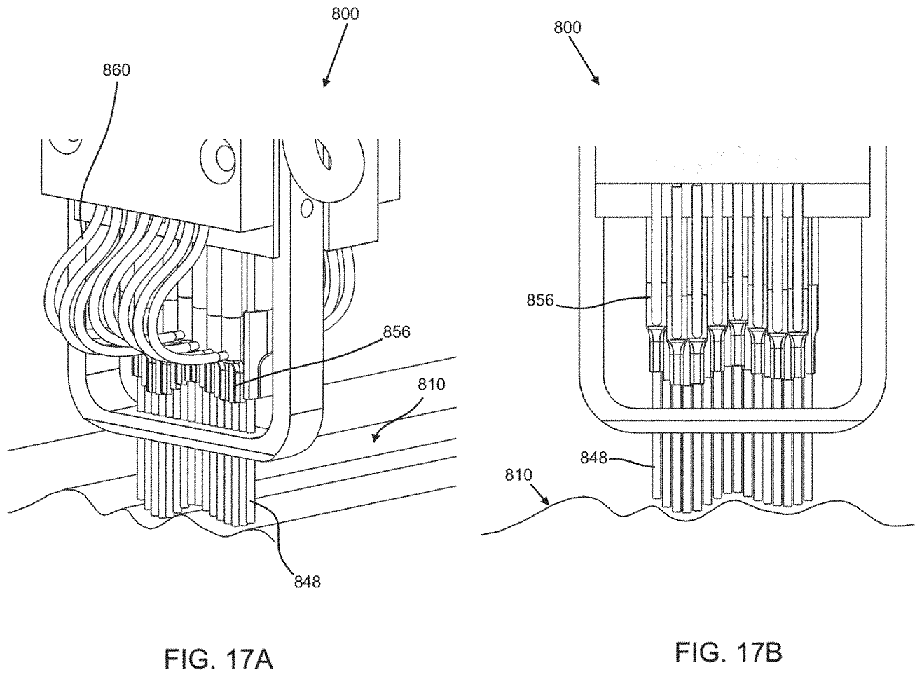

FIG. 17A-B show perspective and front views, respectively, of the multinozzle 800 of FIGS. 15-16B with a profile that has adapted to a printing surface 810 having wave features. As shown, the nozzles 848 have moved vertically with respect to a default position (shown in FIG. 15) such that each tip is located about the same distance from the printing surface 810. The hoses 860 may be relatively flexible such that the fluid path between the ink reservoirs (see FIG. 15) and the nozzle bodies 856 is not interrupted since the hoses 860 is not interrupted by relative movement of the nozzles 848 and nozzle bodies 856.

Although the present disclosure has been described in considerable detail with reference to certain embodiments thereof, other embodiments are possible without departing from the present disclosure. The spirit and scope of the appended claims should not be limited, therefore, to the description of the preferred embodiments contained herein.

All embodiments that come within the meaning of the claims, either literally or by equivalence, are intended to be embraced therein. Further, while multiple dependent claims are not recited below, the invention also embraces embodiments that include all compatible combinations of claimed features and unclaimed features. Further, this application is intended to cover any variations, uses, or adaptations of the present disclosure following the general principles thereof and including such departures from the present disclosure as come within known or customary practice in the art. It is intended that the specification and examples be considered as exemplary only.

It will be appreciated that the present disclosure is not limited to the exact construction that has been described above and illustrated in the accompanying drawings, and that various modifications and changes can be made without departing from the scope thereof.

1. A printhead for 3D printing, the printhead comprising:
a first nozzle with a first opening configured for an extrusion of ink on a printing surface; and
a second nozzle with a second opening configured for an extrusion of ink on the printing surface,
wherein the first nozzle and the second nozzle are positioned to provide simultaneous extrusion of ink on the printing surface, and
wherein a position of the first opening is independently movable relative to a position of the second opening.

2. The printhead of claim 1, further comprising a sensor configured to detect a position of the printing surface relative to at least one of the first nozzle and the second nozzle without contact between the printhead and the printing surface.

3. The printhead of claim 2, further comprising a first actuator and a second actuator mechanically coupled with the first nozzle and the second nozzle, respectively, wherein the first actuator and the second actuator are configured to adjust the respective positions of the first opening and the second opening in response to feedback from the sensor.

4. The printhead of claim 2, wherein the sensor includes at least one of a laser scanner, a camera, and an optical position sensor.

5. The printhead of claim 2, wherein the sensor is movable independently relative to the first nozzle and the second nozzle.

6. The printhead of claim 2, wherein the sensor is coupled to a printhead body of the printhead and is configured to determine a topography of the printing surface in real-time as the printhead body moves along the printing surface.

7. The printhead of claim 1, further comprising a spring device coupled with the first nozzle and configured to provide a default force on the first nozzle.

8. The printhead of claim 1, further comprising a guide element coupled with the first nozzle and configured to contact the printing surface, wherein the contact between the printing surface and the guide element provides an input force for adjusting the position of the first opening.

9. The printhead of claim 8, wherein a terminus of the guide element is offset relative to the first opening of the first nozzle such that when the guide element contacts the printing surface, a space is located between the first opening of the first nozzle and the printing surface.

10. The printhead of claim 1, wherein the printhead includes a printhead body coupled to the first nozzle and the second nozzle, wherein each of the first nozzle and the second nozzle are movable relative to the printhead body, and wherein the printhead body is movable in at least two directions relative to the printing surface.

11-16. (canceled)

17. A printhead for 3D printing, the printhead comprising:
a printhead body;
a nozzle coupled with the printhead body, wherein the nozzle includes an opening configured for extrusion of ink on a printing surface, and wherein the opening of the nozzle is movable relative to the printhead body in response to an input force applied to the nozzle; and
a sensor configured to detect a position of the printing surface relative to the opening of the nozzle and to provide feedback for determining movement of the nozzle based on the position.

18. The printhead of claim 17, wherein feedback from the sensor is provided to an actuator that is mechanically coupled with the nozzle.

19. The printhead of claim 18, wherein the nozzle is fixed relative to a first end of a wire, and wherein the actuator is configured to provide a tension force on the wire to move the nozzle.

20. The printhead of claim 19, wherein the wire extends through a wire conduit of a nozzle body, and wherein the nozzle body is fixed to the nozzle.

21. The printhead of claim 17, further comprising a spring device mechanically coupled with the nozzle and configured to provide a default force on the nozzle.

22. The printhead of claim 21, wherein the spring device is compressed when an actuator moves the nozzle from a default state to a displaced state.

23. The printhead of claim 21, further comprising a second nozzle that is independently movable relative to the nozzle and the printhead body.

24. The printhead of claim 23, a second actuator mechanically coupled with the second nozzle, wherein the second actuator is configured to move a second opening of the second nozzle in response to feedback from the sensor.

25. The printhead of claim 17, wherein the sensor includes at least one of a laser scanner, a camera, and an optical position sensor.

26-36. (canceled)

37. A method for 3D printing, the method comprising:
determining a topography of at least a portion of a printing surface;
extruding a first filament through a first opening of a first nozzle on the portion of printing surface;
extruding a second filament through a second opening of a second nozzle on the portion of the printing surface; and
moving the first opening relative to the second opening while extruding the first filament and the second filament, wherein the movement of the first opening relative to the second opening is based detection of the topography of the printing surface.

38-41. (canceled)
